(19) United States
(12) Patent Application Publication
(10) Pub. No.: US 2026/0270715 A1
(43) Pub. Date: Sep. 10, 2026

(54) DYNAMIC SIGNAL REPRESENTATION SYSTEMS AND METHODS

(71) Applicant: T-Mobile USA, Inc., Bellevue, WA (US)

(72) Inventor: Nirmal Chandrasekaran, Hillsborough, NJ (US)

(21) Appl. No.: 19/074,304

(22) Filed: Mar. 7, 2025

(51) Int. Cl. H04W 16/18; H04W 24/10; H04W 28/02; H04W 28/16

(52) U.S. Cl. CPC H04W 16/18; H04W 24/10; H04W 28/0226; H04W 28/16

(57) ABSTRACT

Systems and methods are disclosed comprising instructions to receive a set of coverage signals for user devices connected to a physical network component of a telecommunications network, generate a coverage snapshot for the time interval that comprises an array of topographic units that correspond to a unique geographic area within the specified range of the physical network component, assign a subset of coverage signals from the received set of coverage signals to each topographic unit, generate a cumulative coverage feature for each topographic unit using the assigned subset of coverage signals, access a displayed map from a user interface corresponding to a geographic area surrounding the physical network component, and dynamically update an overlay layer of the displayed map using the coverage snapshot of the time interval to present a set of graphical elements that visually indicate the cumulative coverage features of the array of topographic units.

### BACKGROUND

A Geographic Information System (GIS) is an organized collection of computer hardware, software, geographic data, and personnel designed to efficiently capture, store, update, manipulate, analyze, and display all forms of geographically referenced information. GIS technology integrates common database operations such as query and statistical analysis with the unique visualization and geographic analysis benefits offered by maps. These abilities distinguish GIS from other information systems and make it valuable to a wide range of public and private enterprises for explaining events, predicting outcomes, and planning strategies. GIS are utilized in multiple technologies, processes, techniques, and methods, including applications within engineering, planning, management, transport/logistics, insurance, telecommunications, and business. For this reason, GIS and location intelligence applications are at the foundation of location-enabled services, which rely on geographic analysis and visualization.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates a network visualization system that can implement aspects of the present technology.

FIG. 3A-3B are block diagrams that illustrate a custom graphical interface that demonstrates aspects of a signal evaluation interface of the network visualization system in accordance with some implementations of the present technology.

FIG. 4 is a flow diagram that illustrates an example process for visualizing network performance in accordance with some implementations of the disclosed technology.

FIG. 5 is a block diagram of an example transformer that can implement aspects of the present technology.

FIG. 6 illustrates a layered architecture of an artificial intelligence (AI) system that can implement the ML models of the network visualization system in accordance with some implementations of the present technology.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Existing network management systems often rely on visualization tools (e.g., geospatial maps) to enhance evaluation and optimization of local network performance. For example, conventional methods typically employ a Geographic Information System (GIS) to measure and identify spatial fluctuations in network performance. These geographic tools enable maintenance personnel (e.g., a telecommunications network provider) to visually detect performance anomalies (e.g., missing coverage, excessive traffic usage, and/or the like) and implement corrective actions (e.g., adjustments to runtime network configuration parameters) to address these afflicted areas. To adequately capture network performance across a given coverage area, these systems typically analyze large collections of network usage information (e.g., mobile device connections, drive test surveys, and/or the like) to create graphical artifacts (e.g., annotated topography) that geospatially map target performance metrics. However, traditional systems often require significant processing time and resource expenditure (e.g., computing power, financial costs, and/or the like) to generate component visuals (e.g., geographic map for a specified timestamp) due to the extensive size of these collected datasets, which limits network evaluation to infrequent intervals (e.g., weekly, monthly, annually, ad-hoc, and/or the like). As a result, these systems generally fail to provide granular visualizations of minute transitions and/or patterns in network performance between short time intervals (e.g., near real-time). Thus, these and other problems of conventional network evaluation strategies can negatively impact telecommunication service providers, place undue burden on maintenance support teams, cause downstream effects that diminish the overall user (e.g., network subscriber) experience, and so forth.

Disclosed herein are efficient systems and related methods for generation of progressive network performance visualization tools (e.g., a time-lapse annotated geospatial map) between granular time intervals (e.g., near real-time, short actionable response time, and/or the like). The disclosed system compartmentalizes captured geospatial device coverage signals (e.g., mobile user device connection data) to reductively generate approximate performance snapshots of a given network component (e.g., a cell tower) at discrete time intervals. By selectively grouping network coverage signals according to broader topographic areas, the system expedites generation of graphic snapshots between shorter time intervals while maintaining sufficient details (e.g., aggregate performance metrics) for interpretive fidelity.

In some implementations, the system can identify a set of anomalous geographic areas that demonstrate abnormal network coverage patterns (e.g., reduced coverage, traffic congestion, and/or the like) between subsequent time intervals. As an example, the system can group captured device coverage signals based on proximate density (e.g., concentration of captured signals) to generate topographic clusters (e.g., bounded geographic areas) within the network coverage area. By comparing aggregate performance metrics (e.g., signal quality, signal strength, data throughput, and/or the like) of the topographic clusters between two time intervals, the system can identify anomalous coverage areas that fail to satisfy a network stability threshold. Accordingly, the system can dynamically resolve identified abnormal network performance by updating specific network configuration parameters that impact the afflicted coverage areas.

Advantages of the disclosed system include a streamlined data visualization process that can efficiently produce detailed graphic snapshots (e.g., annotated topographic maps) of network coverage performance between short time intervals. As a result, the system can generate granular visual transitions (e.g., a time-lapsed video) of network coverage patterns, enabling authorized users (e.g., maintenance staff, service providers, and/or the like) to easily identify, and mitigate, abnormal network performance prior to experiencing negative downstream effects. Furthermore, the disclosed technology assists users in automatically, or semi-automatically, adjusting critical network configuration parameters to resolve detected anomalous network coverage patterns.

For illustrative purposes, examples are described herein in the context of efficient time-lapsed visualization of captured device coverage signals for a telecommunications network. However, a person skilled in the art will appreciate that the disclosed system can be applied in other contexts. For example, the disclosed methods can be used to enhance generation of granular visualization tools (e.g., time-lapsed graphics) within computing systems that rely on geospatial analysis, such as traffic management systems (e.g., monitored congestion), aerospace systems (e.g., airspace occupancy), cybersecurity systems (e.g., origin of malicious software), and/or healthcare systems (e.g., sources of epidemics).

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

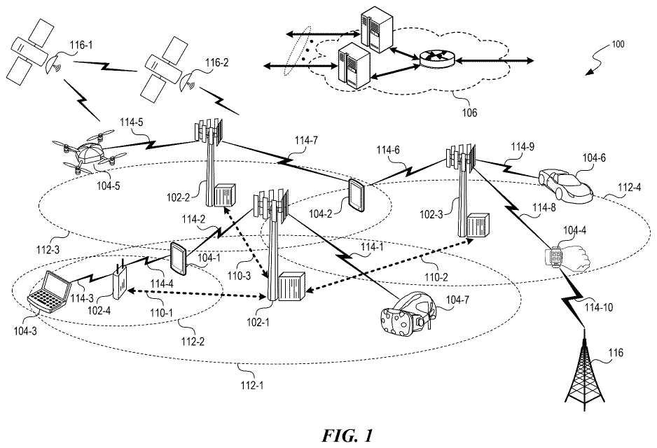

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Network Visualization System

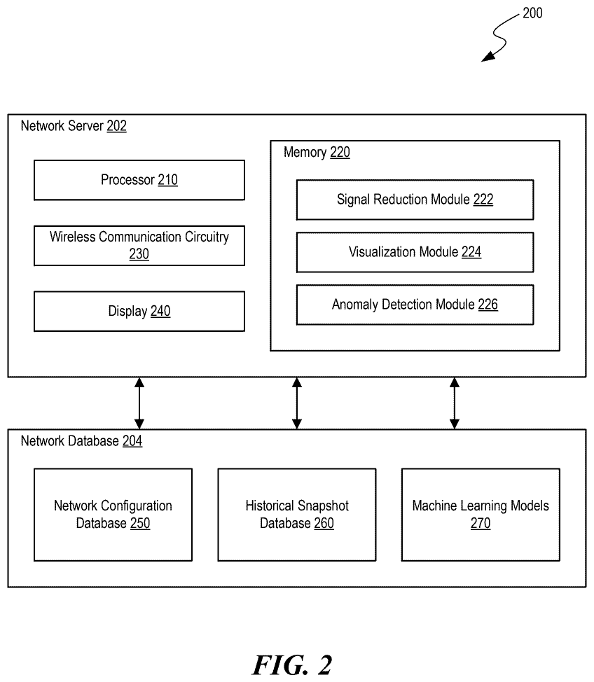

FIG. 2 is a block diagram that illustrates a network visualization system 200 (“system 200”) that can implement aspects of the present technology. The components shown in FIG. 2 are merely illustrative, and well-known components are omitted for brevity. As shown, the network server 202 includes a processor 210, a memory 220, a wireless communication circuitry 230 to establish wireless communication and/or information channels (e.g., Wi-Fi, internet, APIs, communication standards) with other computing devices and/or services (e.g., servers, databases, cloud infrastructure), and a display 240 (e.g., user interface). In alternative implementations, the system 200 can be communicatively coupled to the display 240 as an external interface device that is separate from the system 200. The processor 210 can have generic characteristics similar to general-purpose processors, or the processor 210 can be an application-specific integrated circuit (ASIC) that provides arithmetic and control functions to the network server 202. While not shown, the processor 210 can include a dedicated cache memory. The processor 210 can be coupled to all components of the network server 202, either directly or indirectly, for data communication. Further, the processor 210 of the network server 202 can be communicatively coupled to a computing database 204 that is hosted alongside the network server 202 on the core network 106 described in reference to FIG. 1. As shown, the network database 204 can include a network configuration database 250, a historical snapshot database 260, and/or a machine learning models 270 database.

The memory 220 can comprise any suitable type of storage device including, for example, a static random-access memory (SRAM), dynamic random-access memory (DRAM), electrically erasable programmable read-only memory (EEPROM), flash memory, latches, and/or registers. In addition to storing instructions that can be executed by the processor 210, the memory 220 can also store data generated by the processor 210 (e.g., when executing the modules of an optimization platform). In additional, or alternative, embodiments, the processor 210 can store temporary information onto the memory 220 and store long-term data onto the network database 204. The memory 220 is merely an abstract representation of a storage environment. Hence, in some embodiments, the memory 220 comprises one or more actual memory chips or modules.

As shown in FIG. 2, modules of the memory 220 can include a signal reduction module 222, a visualization module 224, and/or an anomaly detection module 226. Other implementations of the network server 202 include additional, fewer, or different modules or distribute functionality differently between the modules. As used herein, the term “module” refers broadly to software components, firmware components, and/or hardware components. Accordingly, the modules 222, 224, 226 could each comprise software, firmware, and/or hardware components implemented in, or accessible to, the network server 202.

The signal reduction module 222 can capture a collection of geolocated device coverage reports (e.g., or signals) associated with component networks (e.g., a cell tower, a network site, rooftop hardware, and/or the like) of a telecommunications network. For example, the signal reduction module 222 can configure the wireless communication circuitry 230 to actively monitor network activity (e.g., via real-time application programming interfaces (APIs), passive background listening programs, and/or the like) and detect incoming device reports pertaining to local wireless device (e.g., a mobile user device, a drive test survey module, and/or the like) connections and/or data transfer requests to a target component network. In particular, each geolocated device coverage report can comprise identifiable information (e.g., latitude and/or longitude of remote device, reporting timestamp, and/or the like) and measured performance attributes (e.g., signal strength, signal quality, latency, packet loss, data throughput, and/or the like) that characterize a communicative state and/or interaction between the target network component and the corresponding local wireless device.

In some implementations, the signal reduction module 222 can accumulate monitored coverage reports within regular time intervals to generate, and/or store (e.g., at the historical snapshot database 260), a time-series sequence of coverage report datasets. For example, the signal reduction module 222 can dynamically assign each received geolocated device coverage report to a collection of report samples associated with a time interval that captures the reporting timestamps of the member report samples. In additional or alternative implementations, the signal reduction module 222 can communicatively connect to stored repositories (e.g., a crowdsourced dataset, a remote archive collection, and/or the like) and access historical geolocated device coverage reports that are captured during a prior time interval.

The signal reduction module 222 can assign received geolocated device coverage reports (e.g., or signals) to discrete topographic units that correspond to bounded geographic areas within a network coverage area of a target network component. For example, the signal reduction module 222 can use geospatial information (e.g., longitude, latitude, altitude, and/or the like) of a coverage report to identify a corresponding bounded geographic area. Accordingly, the signal reduction module 222 can assign the coverage report to the topographic unit that corresponds to the identified bounded geographic area. In some implementations, the signal reduction module 222 can use a standard geometric region (e.g., a triangle, a quadrilateral, a hexagon, and/or the like) to define the bounded geographic areas within the network coverage area. In other implementations, the signal reduction module 222 can assign device coverage reports to topographic units that correspond to specific time intervals. For example, the signal reduction module 222 can use a reporting timestamp of a coverage report to identify a corresponding time interval that includes the reporting timestamp. Accordingly, the signal reduction module 222 can assign the coverage report to the topographic unit that corresponds to the identified time interval.

In some implementations, the signal reduction module 222 can also assign the received geolocated device coverage reports (e.g., or signals) to separate categorical groups that correspond to coverage attributes (e.g., network layer, geographic sector, and/or the like) of the target network component. For example, the signal reduction module 222 can identify a network bandwidth layer (e.g., a low band, a mid band, a high band, and/or the like) used to connect the local wireless device (e.g., of the coverage report) to the target network component. Accordingly, the signal reduction module 222 can assign the coverage report to the coverage attribute that corresponds to the identified network bandwidth layer. In another example, the signal reduction module 222 can identify a geographic sector (e.g., a radial coverage area) from which the local wireless device (e.g., of the coverage report) connects and/or interacts with the target network component. Accordingly, the signal reduction module 222 can assign the coverage report to the coverage attribute that corresponds to the identified geographic sector.

The signal reduction module 222 can generate cumulative network coverage features (e.g., quantitative attributes, categorical labels, and/or the like) for each discrete topographic unit. For example, the signal reduction module 222 can apply statistical approximation algorithms (e.g., an averaging function, a machine learning model 270, and/or the like) to analyze individual network performance metrics of coverage reports (e.g., that are assigned to a topographic unit) to generate a noise-reduced summative feature (e.g., an average signal strength). In some implementations, the signal reduction module 222 can generate a differential cumulative feature that represents a progressive variation (e.g., a quantitative gradient) in network coverage features between time intervals. For example, the signal reduction module 222 can use the statistical approximation algorithms to generate a first summative feature for a first set of coverage reports assigned to the topographic unit that correspond to a first time interval. The signal reduction module 222 can also use the statistical approximation algorithms to generate a second summative feature for a second set of coverage reports assigned to the topographic unit that correspond to a second time interval (e.g., separate from the first time interval). Accordingly, the signal reduction module 222 can calculate a difference measure (e.g., a quantitative variation, a rate of change, and/or the like) based on a comparison of the first and the second summative features for the topographic unit.

The visualization module 224 can generate snapshot data configurations (or alternatively as “coverage snapshots” or “snapshots”) that assembles topographic units of a target network component according to one or more visual presentation parameters and/or filters (e.g., a time duration, a time interval, a network attribute). For example, the visualization module 224 can generate an individual snapshot instance that maps together topographic units corresponding to a specified time duration (e.g., a set of time intervals). In another example, the visualization module 224 can generate an individual snapshot instance that maps together topographic units corresponding to a specified categorical group (e.g., network layer, geographic sector) of the target network component. In a further example, the visualization module 224 can generate an individual snapshot instance that maps together topographic units corresponding to a combination of a time duration and/or categorical groups of the target network component (e.g., topographic units for bounded geographic areas at specific time intervals). The visualization module 224 can be configured to store generated snapshot configurations at the historical snapshot database 260.

In some implementations, the visualization module 224 can combine multiple snapshot configurations to generate a sequential representation of network coverage associated with a target network component. For example, the visualization module 224 can generate a sequence of individual snapshot instances (e.g., of the target network component) such that each instance corresponds to a regular time interval (e.g., a periodic frequency) between an initial timestamp and a termination timestamp. The visualization module 224 can be configured to dynamically generate, and/or update, a time-series sequence of snapshot configurations in real-time as additional device coverage reports associated with the target network component are continuously received. In additional or alternative implementations, the visualization module 224 can be configured to generate and store generated sequences of snapshot configurations, including variations thereof, at the historical snapshot database 260.

The anomaly detection module 226 can compare snapshot configurations between time intervals to identify anomalous network coverage areas for a target network component. For example, the anomaly detection module 226 can selectively compare at least two snapshot configurations (e.g., from a sequence of snapshots) that correspond to separate time intervals. For each individual snapshot configuration, the anomaly detection module 226 can generate one or more topographic cluster groups (or alternatively “topographic clusters”) by combining topographic units of the snapshot that comprise device coverage reports with geographic locations that are within a proximate distance with one another (e.g., satisfaction of a local proximity threshold, geospatial density, and/or the like). In alternative implementations, the anomaly detection module 226 can apply a machine learning model 270 (e.g., a neural network, an unsupervised learning algorithm, and/or the like) to approximate the one or more topographic clusters for each snapshot. In some implementations, the anomaly detection module 226 can use the same topographic cluster groups (e.g., identical topographic cluster schemas) across each snapshot configuration. In alternative implementations, the anomaly detection module 226 can generate separate topographic cluster groups for each individual snapshot configuration. Using a machine learning model 270 (e.g., isolated forest algorithm, neural networks, and/or the like), the anomaly detection module 226 can compare spatial (e.g., geographic areas) and/or performance (e.g., signal quality) attributes of the topological clusters between the at least two snapshots to identify a subset of anomalous topographic clusters that correspond to abnormal network performance (e.g., sudden network outage, rapid increase in network usage, and/or the like).

In some implementations, the anomaly detection module 226 can automatically execute corrective actions in response to detecting one or more anomalous topographic clusters associated with a target network component. For example, the anomaly detection module 226 can determine anomalous geographic regions based on the geographic areas corresponding to topographic units of the anomalous topographic clusters. Accordingly, the anomaly detection module 226 can reconfigure mutable network parameters (e.g., from the network configuration database 250) of the target network component that modify one or more runtime network functions associated with the identified anomalous geographic regions. In other implementations, the anomaly detection module 226 can automatically generate, and transmit, a notification alert to users (e.g., authorized users, maintenance personnel, and/or the like) that indicates a recommended maintenance review of the target network component. For example, the anomaly detection module 226 can configure the notification alert to present a summarized report that comprises diagnostic information (e.g., observed abnormal network performance) corresponding to the target network component, such as the identified anomalous topographic clusters, topographic units, anomalous geographic regions, sequences of snapshot configurations, and/or specific device coverage reports (e.g., or signals). In another example, the anomaly detection module 226 can configure the notification alert to recommend users with an optimal set of visual presentation parameters (e.g., a time duration, a geographic area, a network layer, and/or the like) to magnify the identified abnormal network performance on the custom graphical interface 300. In another example, the anomaly detection module 226 can configure the notification alert to present users with a human-readable narrative that explains the evaluation methods and/or results used to determine the identified abnormal network performance. In some implementations, the anomaly detection module 226 can use a generative machine learning model (e.g., a large language model) to generate the human-readable narrative.

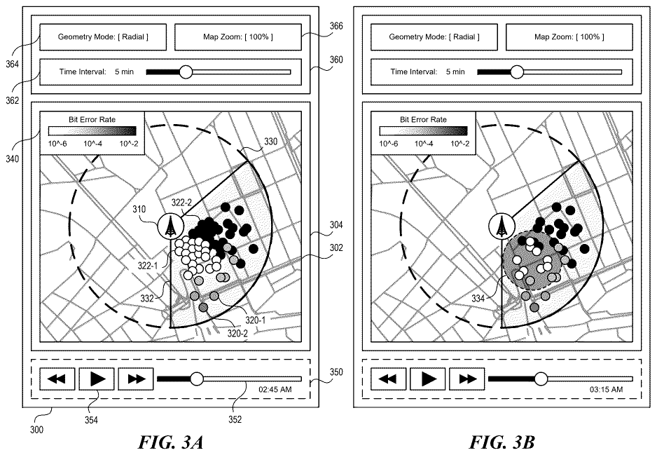

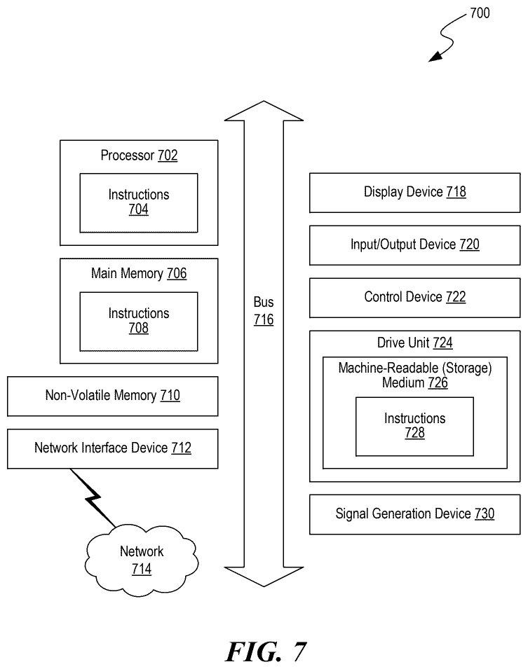

FIG. 3A-3B are block diagrams that illustrate a custom graphical interface 300 (“interface 300”) that demonstrates aspects of a signal evaluation interface of the network visualization system of FIG. 2 in accordance with some implementations of the present technology. Interface 300 is implemented using components of the example computer system 700 illustrated and described in more detail with reference to FIG. 7. Likewise, implementations of interface 300 can include different and/or additional components or can be connected in different ways. Interface 300 is a visual interface that allows users (e.g., an authorized user) to interact with electronic devices using graphical elements (e.g., windows, icons, buttons, and/or the like) rather than text-based commands. As described herein, the visualization module 224 of the network server 202 with reference to FIG. 2 can configure one or more visual and/or interactive components of the interface 300.

The visualization module 224 can configure the interface 300 to display a dynamic graphic representation of a snapshot configuration for a network component 310. As shown in FIG. 3A, the visualization module 224 can configure the interface 300 to display a static base map 302 (e.g., a top-down perspective image) depicting a geographic area that comprises the network coverage area 330 of the network component 310. The visualization module 224 can also configure the interface 300 to display a mutable overlay layer 304 that overlaps the static base map 302 and enables custom graphical elements (e.g., icons, text, and/or the like) to visually reside above the static base map 302. The visualization module 224 can configure the overlay layer 304 to comprise one or more graphical elements (e.g., dotted lines, shaded areas, and/or the like) that visually demarcate approximate boundaries of the coverage area 330, sector coverage areas 332, and/or anomalous geographic regions 334 of the network component 310.

As shown in FIG. 3A, the visualization module 224 can configure the overlay layer 304 to comprise one or more graphical elements (e.g., dots, icons, geometric boundaries, and/or the like) that correspond to topographic units 320 of the snapshot configuration. Accordingly, the visualization module 224 can configure each topographic unit 320 to display a visible pattern (e.g., a color gradient, a classification label, and/or the like) that indicates the cumulative coverage feature (e.g., average network performance measure) assigned to the topographic unit 320. As illustrated in FIG. 3A, the overlay layer 304 can comprise a first topographic unit 320-1 that displays a visual pattern that corresponds to a first cumulative coverage feature (e.g., low quantitative performance measure) and a second topographic unit 320-2 that displays a visual pattern that corresponds to a second cumulative coverage feature (e.g., high quantitative performance measure). In some implementations, the visualization module 224 can configure the overlay layer 304 to comprise a feature reference table 340 (e.g., a color gradient, an icon legend, and/or the like) that maps the visual patterns of displayed topographic units 320 to corresponding cumulative coverage features.

In some implementations, the visualization module 224 can configure the overlay layer 304 to display a plurality of intermediate overlay layers that can overlap graphical elements on top of each other. Accordingly, the visualization module 224 can configure the overlay layer 304 to display an overlapping stack of graphical elements that correspond to separate groups of topographic units, such as topographic units assigned to separate coverage categorical groups (e.g., network layers) of the network component 310. As illustrated in FIG. 3A, the visualization module 224 can configure the overlay layer 304 to display a first intermediate overlay layer that comprises a first group of topographic units 322-1 on top of a second intermediate overlay layer that comprises a second group of topographic units 322-2, resulting in a non-visible subset of topographic units 322-2 from the second group.

The visualization module 224 can configure the interface 300 to present interactive graphical elements (e.g., a button, a slider, a link, and/or the like) that updates the overlay layer 304 when activated by an external user (e.g., an authorized user, maintenance staff personnel, and/or the like). For example, the visualization module 224 can configure the interface 300 to present one or more sequence playback controls 350 that corresponds to a sequence of snapshot configurations (e.g., a time-lapsed sequence) for the network component 310. In particular, the visualization module 224 can configure the sequence playback controls 350 to comprise a playback slider 352 (e.g., a scrollable timeline) and/or a playback button 354 (e.g., a play, a pause, and/or stop button) that, when activated by the external user, modifies the graphical elements of the overlay layer 304 to display a different snapshot configuration from the sequence. As illustrated in FIG. 3B, the overlay layer 304 of the interface 300 can be configured to display topographic units 320 of a second snapshot configuration that corresponds to a different timestamp.

In some implementations, the visualization module 224 can configure the interface 300 to present a snapshot configuration menu 360 that modifies one or more properties of a sequence of snapshot configurations for the network component 310. For example, the visualization module 224 can configure the configuration menu 360 to comprise a granularity slider 362, a unit geometry mode 364, and/or a magnification feature 366 (e.g., size of topographic units), that, when activated by the external user, modifies properties of the sequence of snapshot configurations for the network component 310. For example, the granularity slider 362 enables the external user to modify the length of time intervals between individual snapshots within the sequence. In another example, the unit geometry mode 364 enables the external user to modify the geographic shape and/or area that corresponds to topographic units of individual snapshot configurations. In another example, the magnification feature 366 enables the external user to scale the geographic shape and/or area that corresponds topographic units of the snapshot configurations. Accordingly, the network server 202 can generate, and display, a new sequence of snapshot configurations based on user selected modifications via the configuration menu 360.

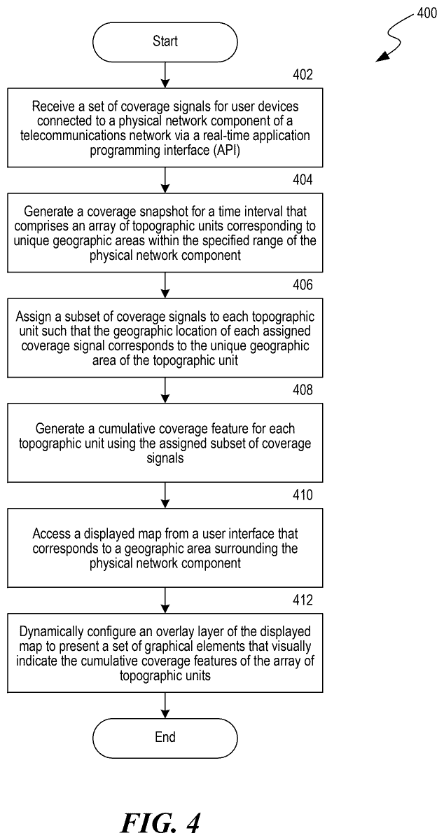

FIG. 4 is a flow diagram that illustrates an example process 400 for visualizing network performance in accordance with some implementations of the disclosed technology. The process 400 can be a computer-implemented method performed by a system (e.g., network visualization system 200) configured to generate, and display, an approximate snapshot of network coverage signals that correspond to a specified time interval. In one example, the system includes at least one hardware processor and at least one non-transitory memory storing instructions, which, when executed by the at least one hardware processor, cause the system to perform the process 400. In another example, the system includes a non-transitory, computer-readable storage medium comprising instructions recorded thereon, which, when executed by at least one data processor, cause the system to perform the process 400.

At 402, the system can receive a set of coverage signals for user devices connected to a physical network component of a telecommunications network. For example, the system can use a real-time application programming interface (API) to receive coverage signals that each comprise a timestamp corresponding to a time interval and/or a geographic location within a specified range of the physical network component. In some implementations, the set of coverage signals for user devices connected to a physical network component can comprise a signal strength, a signal quality, a coverage area, a data throughput, a data latency, a call quality, a set of key network performance indicators, and/or a combination thereof.

At 404, the system can generate a coverage snapshot for the time interval that comprises an array of topographic units such that each topographic unit corresponds to a unique geographic area within the specified range of the physical network component. In some implementations, the array of topological units can comprise a first set of topological units corresponding to geographic areas within a first network coverage area and a second set of topological units corresponding to geographic areas within a second network coverage area that is separate from the first network coverage area. In other implementations, the array of topological units can comprise a first set of topological units comprising coverage signals associated with a first network layer and a second set of topological units comprising coverage signals associated with a second network layer that is separate from the first network layer. In further implementations, the array of topographic units can comprise a hexagonal binned histogram plot. In additional or alternative implementations, the system can generate and/or access a plurality of coverage snapshots that correspond to different time intervals. For example, the system can generate the coverage snapshot as a first coverage snapshot for a first time interval that comprises a first array of topographic units. The system can also access (e.g., from a remote database) a second coverage snapshot of a second time interval that comprises a second array of topographic units.

The system can determine representative coverage features (e.g., aggregated quantities, classification labels, and/or the like) for each topographic unit from the array of topographic units of the generated coverage snapshot. For example, at 406, the system can assign a subset of coverage signals from the received set of coverage signals to each topographic unit such that the geographic location of each assigned coverage signal corresponds to the unique geographic area of the topographic unit. Accordingly, at 408, the system can use the assigned subset of coverage signals to generate a cumulative coverage feature for each topographic unit.

The system can use the determined representative coverage features of the coverage snapshot to generate dynamic graphical elements that visualize local network performance. For example, at 410, the system can access a displayed map from a user interface that corresponds to a geographic area surrounding the physical network component. At 412, the system can use the coverage snapshot of the time interval to dynamically configure an overlay layer of the displayed map to present a set of graphical elements that visually indicate the cumulative coverage features of the first array of topographic units. In some implementations, the system can configure each graphical element of the first presented set of graphical elements to comprise a patterned marking (e.g., a color gradient) that corresponds a feature classification label for the indicated cumulative coverage feature.

In some implementations, the system can dynamically configure the overlay layer of the displayed map to update, or modify, one or more presented graphical elements in response to received user actions (e.g., from the user interface). For example, the system can respond to user selection of a second time interval (e.g., separate from the first time interval) by automatically updating the overlay layer to present a second set of graphical elements that visually indicate cumulative coverage features of a second array of topographic units corresponding to a stored second coverage snapshot for the second time interval. In another example, the system can dynamically configure the set of graphical elements to visually indicate cumulative coverage features of a first set of topological units (e.g., of the array of topological units) that corresponds to a first coverage area. In response to user selection to review a second network coverage area, the system can automatically update the set of graphical elements to visually indicate cumulative coverage features of a second set of topological units (e.g., of the array of topological units) that corresponds to the second coverage area. In another example, the system can dynamically configure the overlay layer of the displayed map to present a first subset of graphical elements that visually indicate cumulative coverage features of a first set of topological units (e.g., of the array of topological units) that correspond to a first network layer. The system can further configure the overlay layer to present a second subset of graphical elements that overlap the first subset of graphical elements and visually indicate cumulative coverage features of a second set of topological units (e.g., of the array of topological units) that correspond to a second network layer.

In some implementations, the system can generate a set of topographic clusters that map to the first and the second arrays of topographic units. For example the system generate a set of topographic clusters that each comprise a first subset of topographic units of the first array corresponding to geographic locations that are within a proximate distance of each other, a second subset of topographic units of the second array corresponding to geographic locations that are within the proximate distance of each other, and/or a defined geographic area based on the geographic locations of the first and the second subsets of topographic units. Using a machine learning model 270 (e.g., decision tree algorithms, neural networks, and/or the like), the system can identify a set of anomalous topographic clusters that fail to satisfy a stability threshold when comparing the first and the second subsets of topographic units. Accordingly, the system can dynamically update a set of network configuration parameters for the physical network component that correspond to the defined geographic areas of the identified anomalous topographic clusters. In additional or alternative implementations, the system can prompt a generative machine learning model (e.g., a large language model, natural language processing algorithms, and/or the like) to generate a human-readable narrative that evaluates at least one comparative attribute between the first and the second subsets of topographic units for at least one identified anomalous topographic cluster. Accordingly, the system can transmit a notification alert to a subscribed user recommending maintenance review of network configuration parameters for the physical network component that correspond to the defined geographic area of the at least one identified anomalous topographic cluster such that the notification alert configured to display the generated human-readable narrative.

### Machine Learning Models

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publically-available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

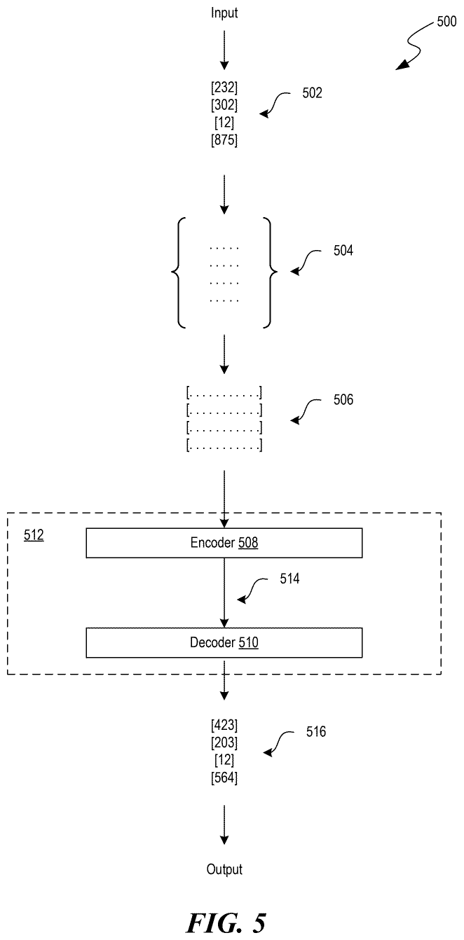

FIG. 5 is a block diagram of an example transformer 512 that can implement aspects of the present technology. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 512 includes an encoder 508 (which can comprise one or more encoder layers/blocks connected in series) and a decoder 510 (which can comprise one or more decoder layers/blocks connected in series). Generally, the encoder 508 and the decoder 510 each include a plurality of neural network layers, at least one of which can be a self-attention layer. The parameters of the neural network layers can be referred to as the parameters of the language model.

The transformer 512 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 512 is trained to perform certain functions on other input formats than natural language input. For example, the input can include objects, images, audio content, or video content, or a combination thereof.

The transformer 512 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 5 illustrates an example of how the transformer 512 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 5, a short sequence of tokens 502 corresponding to the input text is illustrated as input to the transformer 512. Tokenization of the text sequence into the tokens 502 can be performed by some pre-processing tokenization module such as, for example, a byte-pair encoding tokenizer (the “pre” referring to the tokenization occurring prior to the processing of the tokenized input by the LLM), which is not shown in FIG. 5 for simplicity. In general, the token sequence that is inputted to the transformer 512 can be of any length up to a maximum length defined based on the dimensions of the transformer 512. Each token 502 in the token sequence is converted into an embedding vector 506 (also referred to simply as an embedding 506). An embedding 506 is a learned numerical representation (such as, for example, a vector) of a token that captures some semantic meaning of the text segment represented by the token 502. The embedding 506 represents the text segment corresponding to the token 502 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 506 corresponding to the “write” token will be closer to another embedding corresponding to the “jot down” token in the vector space as compared to the distance between the embedding 506 corresponding to the “write” token and another embedding corresponding to the “summary” token.

The vector space can be defined by the dimensions and values of the embedding vectors. Various techniques can be used to convert a token 502 to an embedding 506. For example, another trained ML model can be used to convert the token 502 into an embedding 506. In particular, another trained ML model can be used to convert the token 502 into an embedding 506 in a way that encodes additional information into the embedding 506 (e.g., a trained ML model can encode positional information about the position of the token 502 in the text sequence into the embedding 506). In some examples, the numerical value of the token 502 can be used to look up the corresponding embedding in an embedding matrix 504 (which can be learned during training of the transformer 512).

The generated embeddings 506 are input into the encoder 508. The encoder 508 serves to encode the embeddings 506 into feature vectors 514 that represent the latent features of the embeddings 506. The encoder 508 can encode positional information (i.e., information about the sequence of the input) in the feature vectors 514. The feature vectors 514 can have very high dimensionality (e.g., on the order of thousands or tens of thousands), with each element in a feature vector 514 corresponding to a respective feature. The numerical weight of each element in a feature vector 514 represents the importance of the corresponding feature. The space of all possible feature vectors 514 that can be generated by the encoder 508 can be referred to as the latent space or feature space.

Conceptually, the decoder 510 is designed to map the features represented by the feature vectors 514 into meaningful output, which can depend on the task that was assigned to the transformer 512. For example, if the transformer 512 is used for a translation task, the decoder 510 can map the feature vectors 514 into text output in a target language different from the language of the original tokens 502. Generally, in a generative language model, the decoder 510 serves to decode the feature vectors 514 into a sequence of tokens. The decoder 510 can generate output tokens 516 one by one. Each output token 516 can be fed back as input to the decoder 510 in order to generate the next output token 516. By feeding back the generated output and applying self-attention, the decoder 510 is able to generate a sequence of output tokens 516 that has sequential meaning (e.g., the resulting output text sequence is understandable as a sentence and obeys grammatical rules). The decoder 510 can generate output tokens 516 until a special [EOT] token (indicating the end of the text) is generated. The resulting sequence of output tokens 516 can then be converted to a text sequence in post-processing. For example, each output token 516 can be an integer number that corresponds to a vocabulary index. By looking up the text segment using the vocabulary index, the text segment corresponding to each output token 516 can be retrieved, the text segments can be concatenated together, and the final output text sequence can be obtained.

In some examples, the input provided to the transformer 512 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture 500 for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

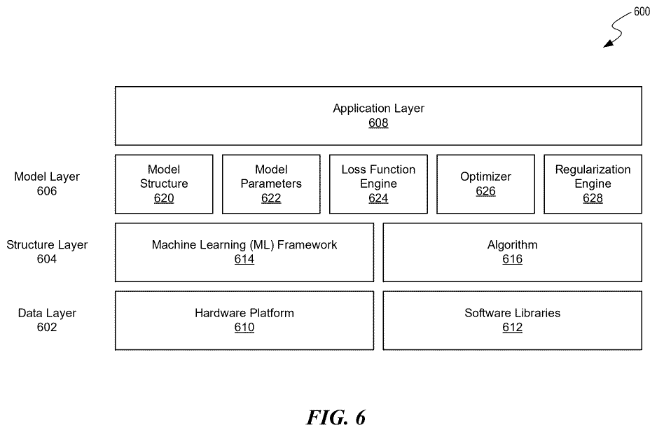

FIG. 6 illustrates a layered architecture of an artificial intelligence (AI) system 600 that can implement the ML models of the network visualization system 200 of FIG. 2, in accordance with some implementations of the present technology. Example ML models can include the models executed by the network visualization system 200. Accordingly, the network visualization system 200 can include one or more components of the AI system 600.

As shown, the AI system 600 can include a set of layers, which conceptually organize elements within an example network topology for the AI system's architecture to implement a particular AI model. Generally, an AI model is a computer-executable program implemented by the AI system 600 that analyses data to make predictions. Information can pass through each layer of the AI system 600 to generate outputs for the AI model. The layers can include a data layer 602, a structure layer 604, a model layer 606, and an application layer 608. The algorithm 616 of the structure layer 604 and the model structure 620 and model parameters 622 of the model layer 606 together form an example AI model. The optimizer 626, loss function engine 624, and regularization engine 628 work to refine and optimize the AI model, and the data layer 602 provides resources and support for application of the AI model by the application layer 608.

The data layer 602 acts as the foundation of the AI system 600 by preparing data for the AI model. As shown, the data layer 602 can include two sub-layers: a hardware platform 610 and one or more software libraries 612. The hardware platform 610 can be designed to perform operations for the AI model and include computing resources for storage, memory, logic and networking, such as the resources described in relation to FIGS. 4 and 6. The hardware platform 610 can process amounts of data using one or more servers. The servers can perform backend operations such as matrix calculations, parallel calculations, machine learning (ML) training, and the like. Examples of servers used by the hardware platform 610 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors, such as application specific integrated circuits (ASIC). GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 610 can include computing resources, (e.g., servers, memory, etc.) offered by a cloud services provider. The hardware platform 610 can also include computer memory for storing data about the AI model, application of the AI model, and training data for the AI model. The computer memory can be a form of random-access memory (RAM), such as dynamic RAM, static RAM, and non-volatile RAM.

The software libraries 612 can be thought of suites of data and programming code, including executables, used to control the computing resources of the hardware platform 610. The programming code can include low-level primitives (e.g., fundamental language elements) that form the foundation of one or more low-level programming languages, such that servers of the hardware platform 610 can use the low-level primitives to carry out specific operations. The low-level programming languages do not require much, if any, abstraction from a computing resource's instruction set architecture, allowing them to run quickly with a small memory footprint. Examples of software libraries 612 that can be included in the AI system 600 include INTEL Math Kernel Library, NVIDIA cuDNN, EIGEN, and OpenBLAS.

The structure layer 604 can include an ML framework 614 and an algorithm 616. The ML framework 614 can be thought of as an interface, library, or tool that allows users to build and deploy the AI model. The ML framework 614 can include an open-source library, an application programming interface (API), a gradient-boosting library, an ensemble method, and/or a deep learning toolkit that work with the layers of the AI system facilitate development of the AI model. For example, the ML framework 614 can distribute processes for application or training of the AI model across multiple resources in the hardware platform 610. The ML framework 614 can also include a set of pre-built components that have the functionality to implement and train the AI model and allow users to use pre-built functions and classes to construct and train the AI model. Thus, the ML framework 614 can be used to facilitate data engineering, development, hyperparameter tuning, testing, and training for the AI model. Examples of ML frameworks 614 that can be used in the AI system 600 include TENSORFLOW, PYTORCH, SCIKIT-LEARN, KERAS, LightGBM, RANDOM FOREST, and AMAZON WEB SERVICES.

The algorithm 616 can be an organized set of computer-executable operations used to generate output data from a set of input data and can be described using pseudocode. The algorithm 616 can include complex code that allows the computing resources to learn from new input data and create new/modified outputs based on what was learned. In some implementations, the algorithm 616 can build the AI model through being trained while running computing resources of the hardware platform 610. This training allows the algorithm 616 to make predictions or decisions without being explicitly programmed to do so. Once trained, the algorithm 616 can run at the computing resources as part of the AI model to make predictions or decisions, improve computing resource performance, or perform tasks. The algorithm 616 can be trained using supervised learning, unsupervised learning, semi-supervised learning, and/or reinforcement learning.

Using supervised learning, the algorithm 616 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. Furthermore, training data can include pre-processed data generated by various engines of the network visualization system 200 described in relation to FIG. 2. The user may label the training data based on one or more classes and trains the AI model by inputting the training data to the algorithm 616. The algorithm determines how to label the new data based on the labeled training data. The user can facilitate collection, labeling, and/or input via the ML framework 614. In some instances, the user may convert the training data to a set of feature vectors for input to the algorithm 616. Once trained, the user can test the algorithm 616 on new data to determine if the algorithm 616 is predicting accurate labels for the new data. For example, the user can use cross-validation methods to test the accuracy of the algorithm 616 and retrain the algorithm 616 on new training data if the results of the cross-validation are below an accuracy threshold.

Supervised learning can involve classification and/or regression. Classification techniques involve teaching the algorithm 616 to identify a category of new observations based on training data and are used when input data for the algorithm 616 is discrete. Said differently, when learning through classification techniques, the algorithm 616 receives training data labeled with categories (e.g., classes) and determines how features observed in the training data (e.g., various claim elements, policy identifiers, tokens extracted from unstructured data) relate to the categories (e.g., risk propensity categories, claim leakage propensity categories, complaint propensity categories). Once trained, the algorithm 616 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 616 is continuous. Regression techniques can be used to train the algorithm 616 to predict or forecast relationships between variables. To train the algorithm 616 using regression techniques, a user can select a regression method for estimating the parameters of the model. The user collects and labels training data that is input to the algorithm 616 such that the algorithm 616 is trained to understand the relationship between data features and the dependent variable(s). Once trained, the algorithm 616 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 616 learns patterns from unlabeled training data. In particular, the algorithm 616 is trained to learn hidden patterns and insights of input data, which can be used for data exploration or for generating new data. Here, the algorithm 616 does not have a predefined output, unlike the labels output when the algorithm 616 is trained using supervised learning. Said another way, unsupervised learning is used to train the algorithm 616 to find an underlying structure of a set of data, group the data according to similarities, and represent that set of data in a compressed format.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 616 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 616 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 616 include factor analysis, item response theory, latent profile analysis, and latent class analysis.

The model layer 606 implements the AI model using data from the data layer and the algorithm 616 and ML framework 614 from the structure layer 604, thus enabling decision-making capabilities of the AI system 600. The model layer 606 includes a model structure 620, model parameters 622, a loss function engine 624, an optimizer 626, and a regularization engine 628.

The model structure 620 describes the architecture of the AI model of the AI system 600. The model structure 620 defines the complexity of the pattern/relationship that the AI model expresses. Examples of structures that can be used as the model structure 620 include decision trees, support vector machines, regression analyses, Bayesian networks, Gaussian processes, genetic algorithms, and artificial neural networks (or, simply, neural networks). The model structure 620 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 620 may include one or more hidden layers of nodes between the input and output layers. The model structure 620 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 622 represent the relationships learned during training and can be used to make predictions and decisions based on input data. The model parameters 622 can weight and bias the nodes and connections of the model structure 620. For instance, when the model structure 620 is a neural network, the model parameters 622 can weight and bias the nodes in each layer of the neural networks, such that the weights determine the strength of the nodes and the biases determine the thresholds for the activation functions of each node. The model parameters 622, in conjunction with the activation functions of the nodes, determine how input data is transformed into desired outputs. The model parameters 622 can be determined and/or altered during training of the algorithm 616.

The loss function engine 624 can determine a loss function, which is a metric used to evaluate the AI model's performance during training. For instance, the loss function engine 624 can measure the difference between a predicted output of the AI model and the actual output of the AI model and is used to guide optimization of the AI model during training to minimize the loss function. The loss function may be presented via the ML framework 614, such that a user can determine whether to retrain or otherwise alter the algorithm 616 if the loss function is over a threshold. In some instances, the algorithm 616 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 626 adjusts the model parameters 622 to minimize the loss function during training of the algorithm 616. In other words, the optimizer 626 uses the loss function generated by the loss function engine 624 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 626 used may be determined based on the type of model structure 620 and the size of data and the computing resources available in the data layer 602.

The regularization engine 628 executes regularization operations. Regularization is a technique that prevents over-and under-fitting of the AI model. Overfitting occurs when the algorithm 616 is overly complex and too adapted to the training data, which can result in poor performance of the AI model. Underfitting occurs when the algorithm 616 is unable to recognize even basic patterns from the training data such that it cannot perform well on training data or on validation data. The optimizer 626 can apply one or more regularization techniques to fit the algorithm 616 to the training data properly, which helps constraint the resulting AI model and improves its ability for generalized application. Examples of regularization techniques include lasso (L1) regularization, ridge (L2) regularization, and elastic (L1 and L2 regularization).

The application layer 608 describes how the AI system 600 is used to solve problem or perform tasks. In an example implementation, the application layer 608 can be communicatively coupled (e.g., display application data, receive user input, and/or the like) to an interactable user interface of the network visualization system 200 of FIG. 2.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A computer-implemented method comprising:
receiving, via a real-time application programming interface (API), a set of coverage signals for user devices connected to a physical network component of a telecommunications network, each coverage signal comprising:
(1) a timestamp corresponding to a first time interval, and
(2) a geographic location within a specified range of the physical network component;
generating a first coverage snapshot for the first time interval that comprises a first array of topographic units, each topographic unit corresponding to a unique geographic area within the specified range of the physical network component;
for each topographic unit from the first array of topographic units:
assigning a subset of coverage signals from the received set of coverage signals to the topographic unit, the geographic location of each assigned coverage signal corresponding to the unique geographic area of the topographic unit, and
generating, using the assigned subset of coverage signals, a cumulative coverage feature for the topographic unit;
accessing, from a user interface, a displayed map corresponding to a geographic area surrounding the physical network component;
dynamically configuring, based on the first coverage snapshot of the first time interval, an overlay layer of the displayed map to present a first set of graphical elements that visually indicate the cumulative coverage features of the first array of topographic units; and
responsive to user selection of a second time interval separate from the first time interval, automatically updating, based on a stored second coverage snapshot of the second time interval, the overlay layer to present a second set of graphical elements that visually indicate the cumulative coverage features of a second array of topographic units of the second coverage snapshot.

2. The method of claim 1 further comprising:
generating a set of topographic clusters that map to the first and the second arrays of topographic units, each topographic cluster comprising:
(1) a first subset of topographic units of the first array corresponding to geographic locations that are within a proximate distance of each other,
(2) a second subset of topographic units of the second array corresponding to geographic locations that are within the proximate distance of each other, and
(3) a defined geographic area based on the geographic locations of the first and the second subsets of topographic units;
identifying, using a machine learning model, a set of anomalous topographic clusters that fail to satisfy a stability threshold when comparing the first and the second subsets of topographic units; and
dynamically updating a set of network configuration parameters for the physical network component that correspond to the defined geographic areas of the identified anomalous topographic clusters.

3. The method of claim 2 further comprising:
prompting a generative machine learning model to generate a human-readable narrative that evaluates at least one comparative attribute between the first and the second subsets of topographic units for at least one identified anomalous topographic cluster; and
transmitting a notification alert to a subscribed user recommending maintenance review of network configuration parameters for the physical network component that correspond to the defined geographic area of the at least one identified anomalous topographic cluster, the notification alert configured to display the generated human-readable narrative.

4. The method of claim 1,
wherein the first array of topological units comprises a first set of topological units corresponding to geographic areas within a first network coverage area and a second set of topological units corresponding to geographic areas within a second network coverage area that is separate from the first network coverage area, and
wherein the method further comprises:
dynamically configuring the first set of graphical elements to visually indicate the cumulative coverage features of the first set of topological units, and
responsive to user selection to review the second network coverage area, automatically updating the first set of graphical elements to visually indicate the cumulative coverage features of the second set of topological units.

5. The method of claim 1,
wherein the first array of topological units comprises a first set of topological units comprising coverage signals associated with a first network layer and a second set of topological units comprising coverage signals associated with a second network layer that is separate from the first network layer, and
wherein the method further comprises:
dynamically configuring the overlay layer of the displayed map to present a first subset of graphical elements that visually indicate the cumulative coverage features of the first set of topological units and a second subset of graphical elements overlapping the first subset of graphical elements that visually indicate the cumulative coverage features of the second set of topological units.

6. The method of claim 1, wherein the set of coverage signals for user devices connected to a physical network component comprises a signal strength, a signal quality, a coverage area, a data throughput, a data latency, a call quality, a set of key network performance indicators, or a combination thereof.

7. The method of claim 1, wherein the first and the second arrays of topographic units comprise a hexagonal binned histogram plot.

8. The method of claim 1, wherein each graphical element of the first presented set of graphical elements comprises a patterned marking that corresponds a feature classification label for the indicated cumulative coverage feature.

9. A system comprising:
at least one hardware processor; and
at least one non-transitory memory storing instructions, which, when executed by the at least one hardware processor, cause the system to:
receive, via a real-time application programming interface (API), a set of coverage signals for user devices connected to a physical network component of a telecommunications network, each coverage signal comprising:
(1) a timestamp corresponding to a time interval, and
(2) a geographic location within a specified range of the physical network component;
generate a coverage snapshot for the time interval that comprises an array of topographic units, each topographic unit corresponding to a unique geographic area within the specified range of the physical network component;
for each topographic unit from the array of topographic units:
assign a subset of coverage signals from the received set of coverage signals to the topographic unit, the geographic location of each assigned coverage signal corresponding to the unique geographic area of the topographic unit, and
generate, using the assigned subset of coverage signals, a cumulative coverage feature for the topographic unit;
access, from a user interface, a displayed map corresponding to a geographic area surrounding the physical network component; and
dynamically update, using the coverage snapshot of the time interval, an overlay layer of the displayed map to present a set of graphical elements that visually indicate the cumulative coverage features of the array of topographic units.

10. The system of claim 9, wherein the array of topographic units is a first array of topographic units, and wherein the system is further caused to:
access, from a remote database, a second coverage snapshot of a second time interval that comprises a second array of topographic units;
generate a set of topographic clusters that map to the first and the second arrays of topographic units, each topographic cluster comprising:
(1) a first subset of topographic units of the first array corresponding to geographic locations that are within a proximate distance of each other,
(2) a second subset of topographic units of the second array corresponding to geographic locations that are within the proximate distance of each other, and
(3) a defined geographic area based on the geographic locations of the first and the second subsets of topographic units;
identify, using a machine learning model, a set of anomalous topographic clusters that fail to satisfy a stability threshold when comparing the first and the second subsets of topographic units; and
dynamically update a set of network configuration parameters for the physical network component that correspond to the defined geographic areas of the identified anomalous topographic clusters.

11. The system of claim 10 further caused to:
prompt a generative machine learning model to generate a human-readable narrative that evaluates at least one comparative attribute between the first and the second subsets of topographic units for at least one identified anomalous topographic cluster; and
transmit a notification alert to a subscribed user recommending maintenance review of network configuration parameters for the physical network component that correspond to the defined geographic area of the at least one identified anomalous topographic cluster, the notification alert configured to display the generated human-readable narrative.

12. The system of claim 9,
wherein the array of topological units comprises a first set of topological units corresponding to geographic areas within a first network coverage area and a second set of topological units corresponding to geographic areas within a second network coverage area that is separate from the first network coverage area, and
wherein the system is further caused to:
dynamically configure the set of graphical elements to visually indicate the cumulative coverage features of the first set of topological units, and
responsive to user selection to review the second network coverage area, automatically update the set of graphical elements to visually indicate the cumulative coverage features of the second set of topological units.

13. The system of claim 9,
wherein the array of topological units comprises a first set of topological units comprising coverage signals associated with a first network layer and a second set of topological units comprising coverage signals associated with a second network layer that is separate from the first network layer, and
wherein the system is further caused to:
dynamically configure the overlay layer of the displayed map to present a first subset of graphical elements that visually indicate the cumulative coverage features of the first set of topological units and a second subset of graphical elements overlapping the first subset of graphical elements that visually indicate the cumulative coverage features of the second set of topological units.

14. The system of claim 9, wherein the set of coverage signals for user devices connected to a physical network component comprises a signal strength, a signal quality, a coverage area, a data throughput, a data latency, a call quality, a set of key network performance indicators, or a combination thereof.

15. A non-transitory computer-readable storage medium comprising instructions recorded thereon, wherein the instructions, when executed by at least one data processor of a system, cause the system to:
receive, via a real-time application programming interface (API), a set of coverage signals for user devices connected to a physical network component of a telecommunications network, each coverage signal comprising:
(1) a timestamp corresponding to a time interval, and
(2) a geographic location within a specified range of the physical network component;
generate a coverage snapshot for the time interval that comprises an array of topographic units, each topographic unit corresponding to a unique geographic area within the specified range of the physical network component;
for each topographic unit from the array of topographic units:
assign a subset of coverage signals from the received set of coverage signals to the topographic unit, the geographic location of each assigned coverage signal corresponding to the unique geographic area of the topographic unit, and
generate, using the assigned subset of coverage signals, a cumulative coverage feature for the topographic unit;
access, from a user interface, a displayed map corresponding to a geographic area surrounding the physical network component; and
dynamically update, using the coverage snapshot of the time interval, an overlay layer of the displayed map to present a set of graphical elements that visually indicate the cumulative coverage features of the array of topographic units.

16. The non-transitory computer-readable storage medium of claim 15, wherein the array of topographic units is a first array of topographic units, and wherein the instructions further cause the system to:
access, from a remote database, a second coverage snapshot of a second time interval that comprises a second array of topographic units;
generate a set of topographic clusters that map to the first and the second arrays of topographic units, each topographic cluster comprising:
(1) a first subset of topographic units of the first array corresponding to geographic locations that are within a proximate distance of each other,
(2) a second subset of topographic units of the second array corresponding to geographic locations that are within the proximate distance of each other, and
(3) a defined geographic area based on the geographic locations of the first and the second subsets of topographic units;
identify, using a machine learning model, a set of anomalous topographic clusters that fail to satisfy a stability threshold when comparing the first and the second subsets of topographic units; and
dynamically update a set of network configuration parameters for the physical network component that correspond to the defined geographic areas of the identified anomalous topographic clusters.

17. The non-transitory computer-readable storage medium of claim 16, wherein the instructions further cause the system to:
prompt a generative machine learning model to generate a human-readable narrative that evaluates at least one comparative attribute between the first and the second subsets of topographic units for at least one identified anomalous topographic cluster; and
transmit a notification alert to a subscribed user recommending maintenance review of network configuration parameters for the physical network component that correspond to the defined geographic area of the at least one identified anomalous topographic cluster, the notification alert configured to display the generated human-readable narrative.

18. The non-transitory computer-readable storage medium of claim 15,
wherein the array of topological units comprises a first set of topological units corresponding to geographic areas within a first network coverage area and a second set of topological units corresponding to geographic areas within a second network coverage area that is separate from the first network coverage area, and
wherein the instructions further cause the system to:
dynamically configure the set of graphical elements to visually indicate the cumulative coverage features of the first set of topological units, and
responsive to user selection to review the second network coverage area, automatically update the set of graphical elements to visually indicate the cumulative coverage features of the second set of topological units.

19. The non-transitory computer-readable storage medium of claim 15,
wherein the array of topological units comprises a first set of topological units comprising coverage signals associated with a first network layer and a second set of topological units comprising coverage signals associated with a second network layer that is separate from the first network layer, and
wherein the instructions further cause the system to:
dynamically configure the overlay layer of the displayed map to present a first subset of graphical elements that visually indicate the cumulative coverage features of the first set of topological units and a second subset of graphical elements overlapping the first subset of graphical elements that visually indicate the cumulative coverage features of the second set of topological units.

20. The non-transitory computer-readable storage medium of claim 15, wherein each graphical element of the presented set of graphical elements comprises a patterned marking that corresponds a feature classification label for the indicated cumulative coverage feature.
